(19) United States
(12) Patent Application Publication
(10) Pub. No.: US 2013/0063071 A1
(43) Pub. Date: Mar. 14, 2013

(54) Forced Air Turbine Electric Automobile (FATE)

(71) Applicant: Donnell Lee Walters, Royse City, TX (US)

(72) Inventor: Donnell Lee Walters, Royse City, TX (US)

(21) Appl. No.: 13/229,414

(22) Filed: Sep. 9, 2011

(51) Int. Cl. H02J 7/00

(52) U.S. Cl. 320/101

(57) ABSTRACT

An electric vehicle for transporting individuals may include an electric motor for powering the electric vehicle, a turbine blade to rotate and being connected to the electric vehicle, a motor/alternator being connected to the turbine blade to generate electric power from the rotation of the turbine blade, a first battery to receive the electric power from the motor/alternator, a second battery to receive the electric power from the motor/alternator and a controller to control the electric power received by the first battery and to control the electric power received by the second battery. The first battery may be only connected to power the electric motor and the second battery may be only connected to receive the electric power from the motor/alternator.

### FIELD OF THE INVENTION

The present invention relates to an electric automobile, and more particularly to an electric automobile that recharges the electric batteries while driving long distances.

### BACKGROUND

As gasoline prices rise, electric vehicles become more desirable. However, one aspect of electric vehicles that these undesirable is the lack of charging stations where these electric vehicles may be recharged. This lack of charging stations results such in a reduced range that the electric vehicles may be used. Furthermore, when electric vehicles are driven especially at high speeds, a significant amount of resistance may be encountered as a result of the vehicle moving through the atmosphere. In a sense, this resistance has been referred to as a type of wind, but this type of wind may be experienced during still air.

### SUMMARY

An electric vehicle for transporting individuals may include an electric motor for powering the electric vehicle, a turbine blade to rotate and being connected to the electric vehicle, a motor/alternator being connected to the turbine blade to generate electric power from the rotation of the turbine blade, a first battery to receive the electric power from the motor/alternator, a second battery to receive the electric power from the motor/alternator and a controller to control the electric power received by the first battery and to control the electric power received by the second battery.

The first battery may be only connected to power the electric motor and the second battery may be only connected to receive the electric power from the motor/alternator.

The second battery may be only connected to power the electric motor, and the first battery may be only connected to receive the electric power from the motor/alternator.

The electric vehicle may include a grill to receive the forced air for the turbine blade. The grill vents may be controlled by the onboard computer to reduce or increase airflow.

The electric vehicle may include a fan for a radiator.

The electric vehicle may include an output port for the forced air.

The output port may be positioned in front of the windshield.

The output port may be positioned in the side of the electric vehicle.

The first battery and the second battery may be positioned adjacent to the electric motor.

The first battery and the second battery may be positioned adjacent to the trunk of the electric vehicle.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the engine compartment of an electric vehicle;

FIG. 2 illustrates a perspective view of the electric vehicle of the present invention;

FIG. 3 illustrates a front view of the electric vehicle of the present invention;

FIG. 4 illustrates a partial view of the motor of the electric vehicle of the present invention;

FIG. 5 illustrates a front view of the engine compartment;

FIG. 6 illustrates a perspective view of the electric vehicle of the present invention;

FIG. 7 illustrates a side view of the grill of the electric vehicle of the present invention;

FIG. 8 illustrates a front view of the grill of the electric vehicle of the present invention;

FIG. 9 illustrates a perspective view of the hood of the electric vehicle of the present invention;

FIG. 10 illustrates a top view of the electric motor and wind turbine of the present invention;

FIG. 11 illustrates a front view of the turbine blade of the wind turbine of the present invention;

FIG. 12 illustrates a top view of the hood of the electric vehicle of the present invention;

FIG. 13 illustrates a perspective view of an output port of the wind turbine of the present invention;

FIG. 14 illustrates a side view of the electric vehicle of the present invention;

FIG. 15 illustrates a front view of the electric vehicle of the present invention

FIG. 16 illustrates a cross-sectional view of the engine compartment of the electric vehicle of the present invention;

FIG. 17 illustrates a front view of the electric vehicle of the present invention;

FIG. 18 illustrates a side view of an embodiment of the electric vehicle of the present invention;

FIG. 19 illustrates a side view of an embodiment of the electric vehicle of the present invention;

FIG. 20 illustrates a top view of a portion of the electric vehicle of the present invention;

FIG. 21 illustrates a exploded view of the electric vehicle of the present invention;

FIG. 22 illustrates a portion of the electric vehicle of the present invention;

FIG. 23 illustrates circuit diagram of the present invention.

### DETAILED DESCRIPTION

The present invention combines wind turbine technology and a battery system which may include at least a first and second battery to alternately recharge one of the first battery or the second battery which may not be currently discharged by the electric vehicle. The present invention may include any number of batteries including a single battery. Consequently, while the first battery is being charged by the wind turbine, the remaining second battery is being discharged by the electric vehicle. After a period of time, the role of these batteries may be switched, resulting in the first battery being discharged by the electric vehicle and the second battery being charged by the wind turbine.

A moderate sized wind turbine could be employed and be driven by the forced air/fluid generated by the movement of the electric vehicle which may be an electric automobile. The wind turbine may be connected to an alternator/motor to convert the energy from the moving shaft of the wind turbine to electrical energy which may be in the form of alternating current (A/C) which may be converted in turn to direct current (D/C) which could be applied to the first or second battery in order to restore the lost energy from discharging. A controller which may be a microprocessor controls a series of switches in order to charge the first or second battery and to allow the battery which is not being charged to power the electric vehicle.

The wind turbine may operate at a higher RPM as the speed of the electric vehicle increases and the higher RPM may result in an increase generation of electric output. The onboard computer may control grill vents to adjust the airflow.

The first and second batteries may allow one of the first and second batteries to receive the electric power and to recharge while the remaining battery is in use powering the main electric motor of the electric vehicle to propel the electric vehicle.

The controller which may be on board the vehicle may be programmed to switch the first battery between being charged from the wind turbine and being discharged to operate the electric vehicle and to switch the second battery between being discharged to operate the electric vehicle and being charge from the wind turbine. The controller may sense the voltage on the battery being charged and stop charging the battery being charged if the battery has become fully charged. The controller may be programmed to switch the in use battery to a recharge mode when the battery voltage of the in use battery reaches a predetermined low level.

The continuous rotating of the first battery and the second battery between the generating state and a discharging state may create a possibility for driving greater distances or possibly unlimited distances.

The advantages of the system may include but not on limited to recharging the first and second batteries while driving the electric vehicle; the electric vehicle may be driven long distances and may provide unlimited travel possibilities; the electric vehicle may be continuously driven without manual recharges; the electric vehicle may not require fuel and may not require oil lubrication; electric vehicle may not emit emissions; the electric vehicle may have low maintenance requirements; the electric vehicle may achieve quiet performance; the forced air airflow may aid in the cooling of the radiator (if present), the electric motor, the brakes and the batteries; the electric vehicle may be recharged when parked in a windy location which may aid in cooling when the electric vehicle is in an idle mode.

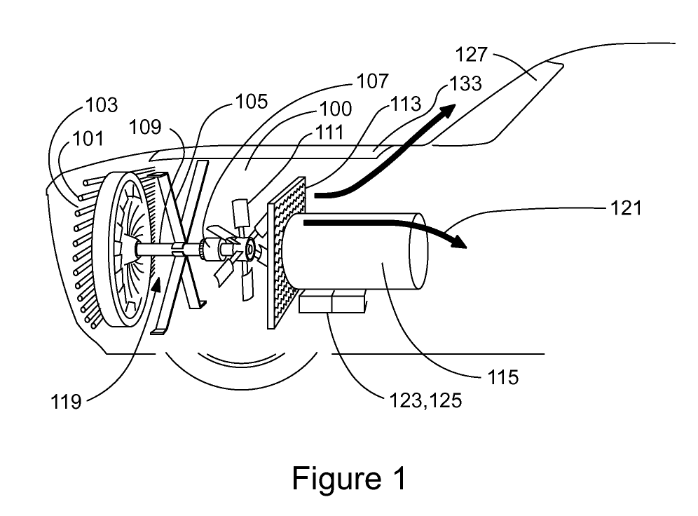

FIG. 1 illustrates a cross-sectional view of the engine compartment of the electric vehicle of the present invention and illustrates a grill 101 which may be an input port to allow the forced air into the engine compartment 100 and which may include slots 103 which may be defined by the grill 101.

A turbine blade 119 may be mounted on a shaft 109 and may be rotated by the forced air entering the grill 101. The turning turbine blade 119 rotates the shaft 109 which may be supported by the turbine frame 105 which may be connected to the engine compartment 100 of the electric vehicle and which may be formed so as to provide a minimum footprint to the forced air which may be moving through the engine compartment 100. The shaft 109 may be connected to a alternator/motor 107 to convert the energy from the rotating shaft 109 into alternating current (A/C) which may be converted to direct current (D/C) which may be stored by the first battery 123 which may be positioned adjacent to the vehicle motor 115 and which may be stored by the second battery 125 which may be positioned adjacent to the vehicle motor 115 and may be opposed to the first battery 123.

FIG. 1 additionally illustrates a radiator fan 111 which may be positioned in front of the radiator/condenser 113 and which may be positioned behind the alternator/motor 107.

FIG. 1 additionally illustrates the airflow 121 of the forced air which may exit the engine compartment below the windshield 127 over in front of the passenger/driver door 129.

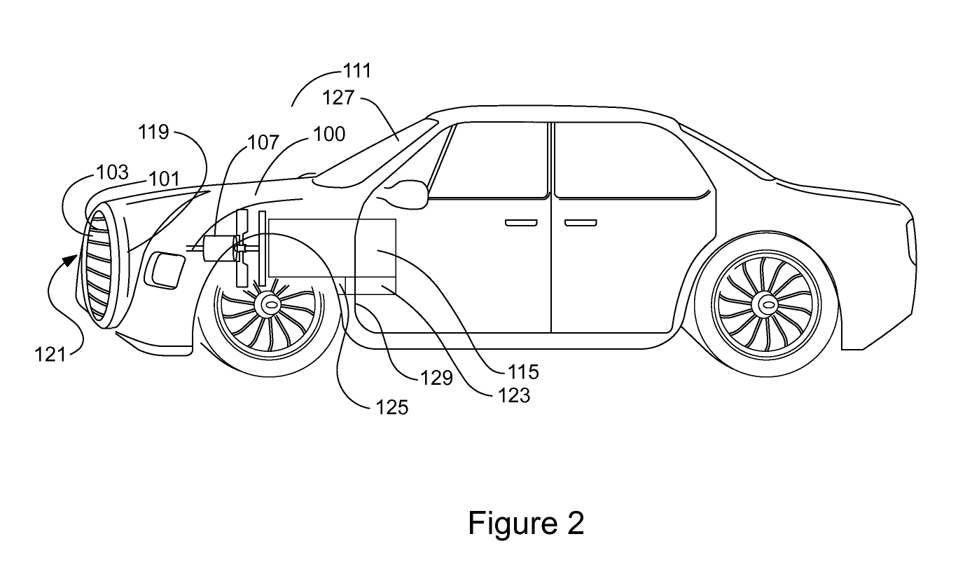

FIG. 2 illustrates a perspective view of the engine compartment 100 of the electric vehicle of the present invention and illustrates a grill 101 which may be an input port to allow the forced air into the engine compartment 100 and which may include slots 103 which may be defined by the grill 101.

A turbine blade 119 may be mounted on a shaft 109 and may be rotated by the forced air entering the grill 101. The turning turbine blade 119 rotates the shaft 109 which may be supported by the turbine frame 105 (not shown) which may be connected to the engine compartment 100 of the electric vehicle and which may be formed so as to provide a minimum footprint to the forced air which may be moving through the engine compartment 100. The shaft 109 may be connected to a alternator/motor 107 to convert the energy from the rotating shaft 109 into alternating current (A/C) which may be converted to direct current (D/C) which may be stored by the first battery 123 which may be positioned adjacent to the vehicle motor 115 and which may be stored by the second battery 125 which may be positioned adjacent to the vehicle motor 115 and may be opposed to the first battery 123.

FIG. 2 additionally illustrates a radiator fan 111 which may be positioned in front of the radiator/condenser 113 and which may be positioned behind the alternator/motor 107.

FIG. 2 additionally illustrates the airflow 121 of the forced air which may exit the engine compartment below the windshield 127 over in front of the passenger/driver door 129.

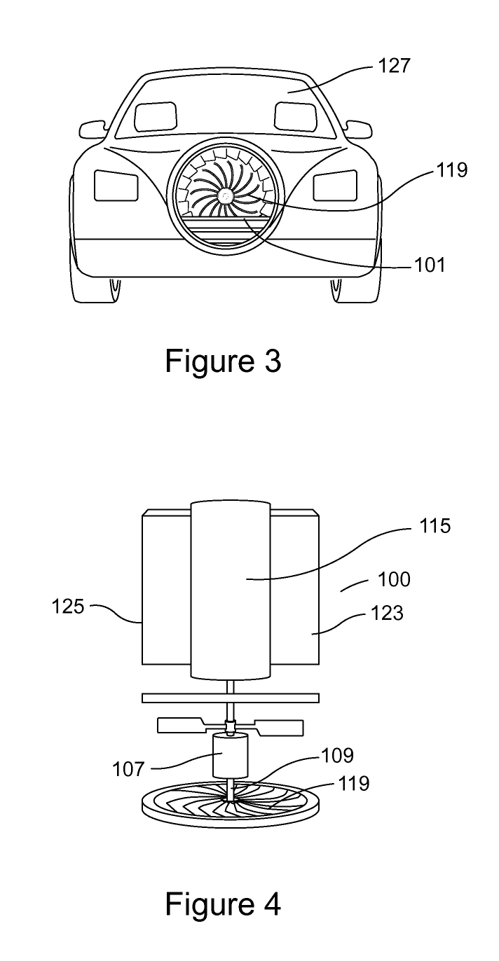

FIG. 3 illustrates a front view of the engine compartment 100 and illustrates the input port 101, the turbine blade 119, and the windshield 127.

FIG. 4 illustrates a top view of the engine compartment 100 and illustrates that the turbine blade 119 may be connected to the shaft 109 which may be connected to the alternator/motor 107 and which is electrically connected to the first battery 123 and the second battery 125. The first battery 123 and the second battery 125 are positioned on opposed sides of the vehicle motor 115.

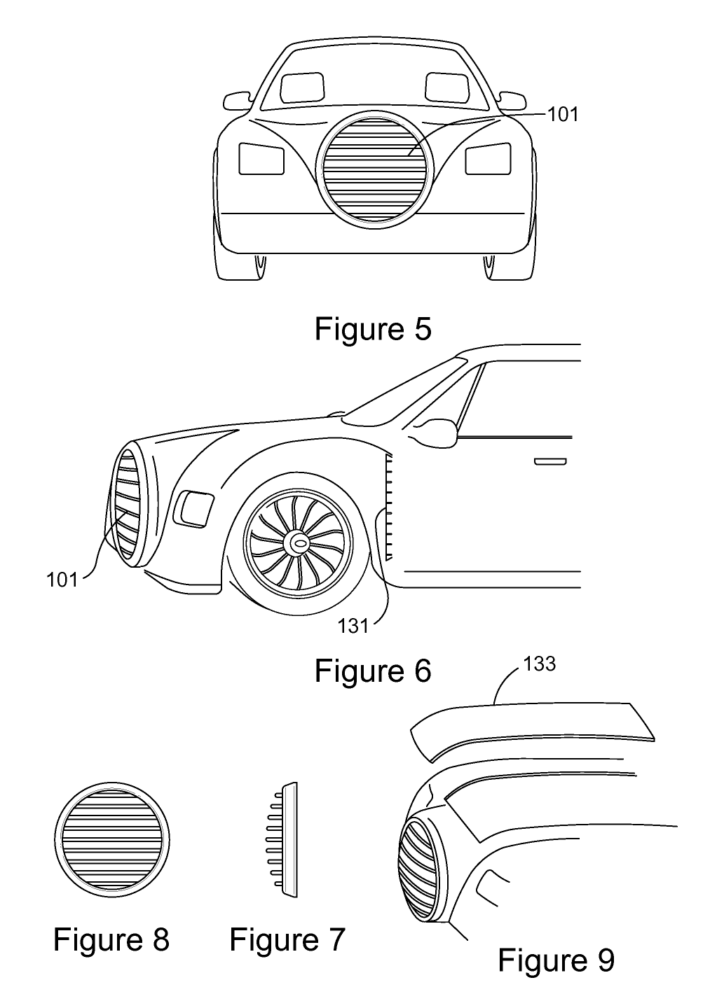

FIG. 5 illustrates a front view of the engine compartment and illustrates the grill 101 which may be a fine mesh in order to protect the turbine blade 119. The grill 101 may be the input port for the forced air.

FIG. 6 illustrates a perspective view of the electric vehicle of the present invention and illustrates an output port 131 to allow the forced air to exit the electric vehicle.

FIG. 7 illustrates a side view of the grill 101 of the electric vehicle of the present invention.

FIG. 8 illustrates a front view of the grill 101 of the electric vehicle of the present invention.

FIG. 9 illustrates a driver side hood latch 133 (hinged on the passenger side) for the electric vehicle.

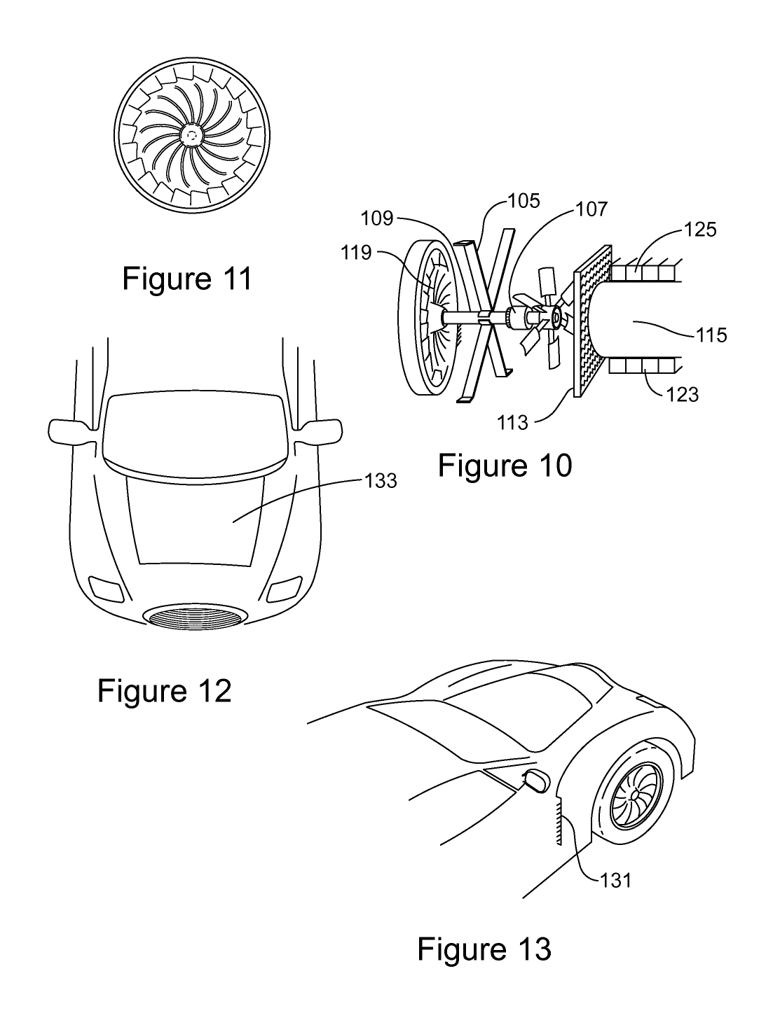

FIG. 10 illustrates a top view of the electric motor 115 and wind turbine of the present invention and illustrates the turbine blade 119 which may be connected to the shaft 109 which may be connected to the turbine frame 105 which may provide a minimum footprint with respect to the forced air.

FIG. 10 additionally illustrates the radiator/condenser 113 positioned in front of the electric motor for the vehicle, the alternator 107, the first battery 123 and a second battery 125.

FIG. 11 illustrates a front view of the turbine blade 119 of the wind turbine of the present invention.

FIG. 12 illustrates a top view of the hood 133 and the indented air channel 117 for exhaust of the electric vehicle of the present invention.

FIG. 13 illustrates a perspective view of an output port 131 of the wind turbine of the present invention.

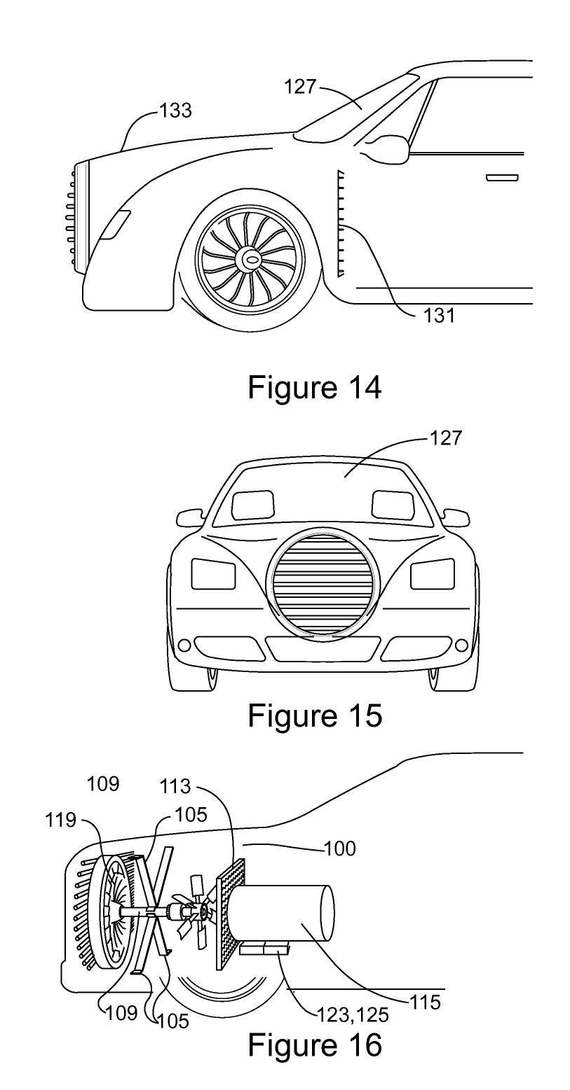

FIG. 14 illustrates a side view of the electric vehicle of the present invention and illustrates the output port 131, the windshield 127 and the vehicle hood 133.

FIG. 15 illustrates a front view of the electric vehicle of the present invention and illustrates the input port or grill 101 and the windshield 127.

FIG. 16 illustrates a cross-sectional view of the engine compartment 100 which may include a turbine blade 119 connected to a shaft 109 which may be positioned in front of a radiator/condenser 113. FIG. 16 additionally illustrates the turbine frame 105 to support the shaft 109 and illustrates the vehicle motor 115 and adjacent to the first battery 123 and a second battery 125.

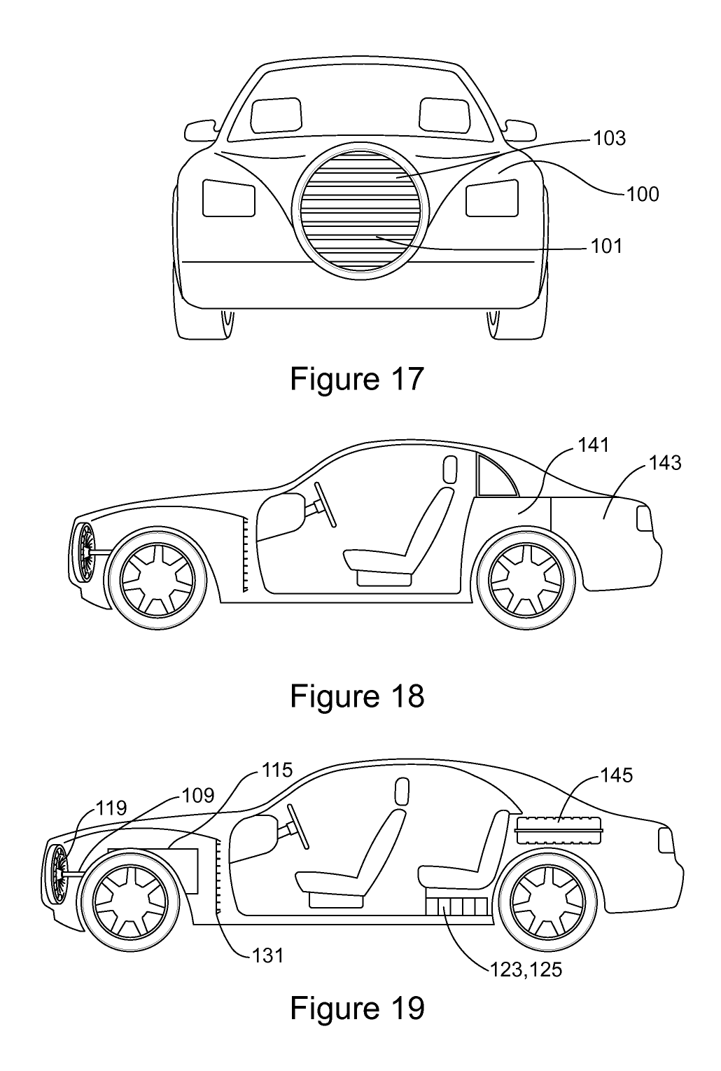

FIG. 17 illustrates a front view of the electric vehicle of the present invention and illustrates the motor compartment 100, the grill 101 and the slot 103.

FIG. 18 illustrates a side view of an embodiment of the electric vehicle of the present invention and illustrates a battery area 141 being positioned adjacent to the trunk 143.

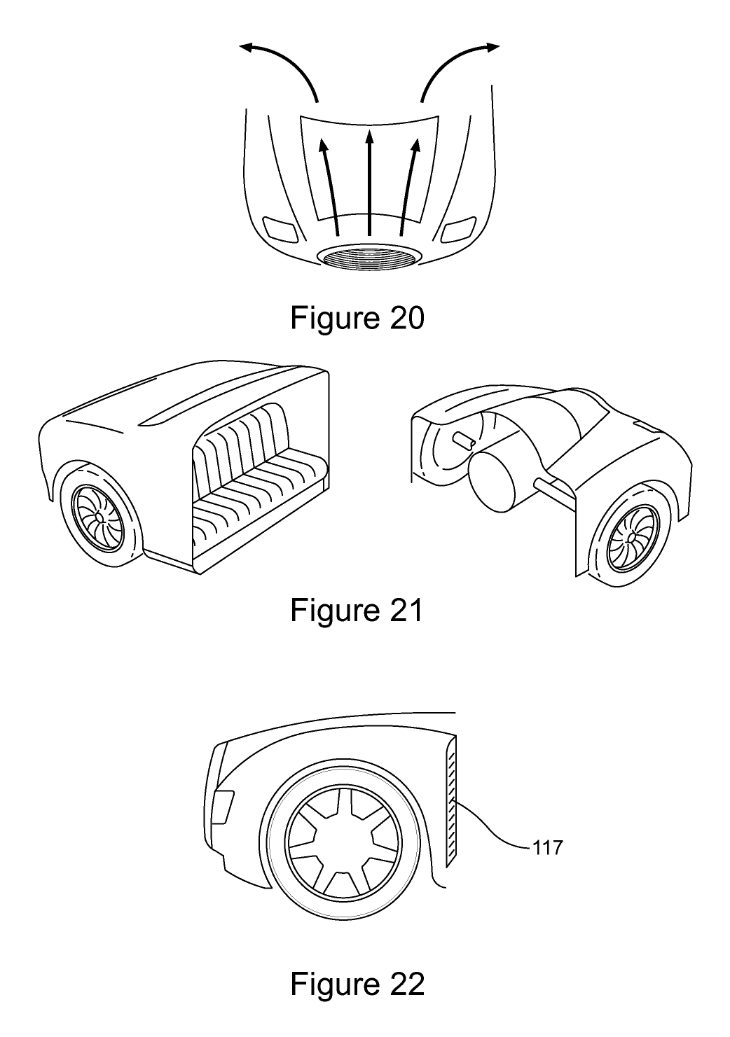

FIG. 19 illustrates a side view of an embodiment of the electric vehicle of the present invention and illustrates the turbine blade 119, the shaft 109, the vehicle motor 115, the output port 131 and a fuel tank 145 or battery area. FIG. 19 additionally illustrates a battery compartment which may be recessed that include the first battery 123 and the second battery 125.

FIG. 20 illustrates a top view of the indented air flow channel 117 for air exhaust the electric vehicle of the present invention;

FIG. 21 illustrates an exploded view of the electric vehicle of the present invention showing airflow channels for the air exhaust 117.

FIG. 22 illustrates a portion of the electrical vehicle of the present invention.

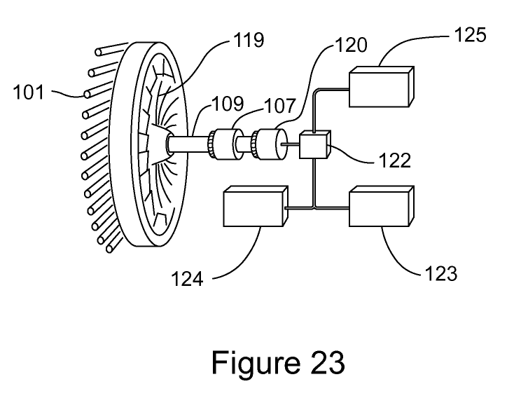

FIG. 23 illustrates the turbine blade 119 which may be mounted on a shaft 109 and may be rotated by the forced air entering the grill 101 (not shown). The turning turbine blade 119 rotates the shaft 109 which may be supported by the turbine frame 105 (not shown in FIG. 23) which may be connected to the engine compartment 100 (not shown) of the electric vehicle and which may be formed so as to provide a minimum footprint to the forced air which may be moving through the engine compartment 100 (not shown). The shaft 109 may be connected to a motor 107 which may be connected to an at will alternator 120 to convert the energy from the rotating shaft 109 into alternating current (A/C) which may be converted to direct current (D/C) by the alternator 120 which may be stored by the first battery 123 which may be positioned adjacent to the vehicle motor 115 and which may be stored by the second battery 125 which may be positioned adjacent to the vehicle motor 115 and may be opposed to the first battery 123.

The controller 124 which may be on board the vehicle may be programmed to switch the first battery 123 between only being charged from the wind turbine and only being discharged to operate the electric vehicle and to switch the second battery 125 between only being discharged to operate the electric vehicle and only being charged from the wind turbine by a switching circuit 122. The controller 124 may sense the voltage on the battery 123, 125 being charged and stop charging the battery 123, 125 being charged if the battery 123, 125 has become fully charged. The controller 124 may be programmed to switch the in use battery 123, 125 to a recharge mode when the battery voltage of the in use battery reaches a predetermined low level.

The continuous rotating of the first battery 123 and the second battery 125 between the generating state and a discharging state may create a possibility for driving greater distances or possibly unlimited distances. The electric vehicle may be a electric automobile, and electric truck, or other types of similar vehicle and may be a hybrid vehicle with an electric motor and a combustion motor.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. An electric vehicle for transporting individuals, comprising:
an electric motor for powering the electric vehicle;
a turbine blade to rotate and being connected to the electric vehicle;
a motor/alternator being connected to the turbine blade to generate electric power from the rotation of the turbine blade;
a first battery to receive the electric power from the motor/alternator;
a second battery to receive the electric power from the motor/alternator;
a controller to control the electric power received by the first battery and to control the electric power received by the second battery;
wherein the first battery is only connected to power the electric motor and the second battery is only connected to receive the electric power from the motor/alternator.

2. An electric vehicle for transporting individuals as in claim 1, wherein the second battery is only connected to power the electric motor and the first battery is only connected to receive the electric power from the motor/alternator.

3. An electric vehicle for transporting individuals as in claim 1, wherein the electric vehicle includes a grill to receive the forced air for the turbine blade.

4. An electric vehicle for transporting individuals as in claim 1, wherein the electric vehicle includes a fan for a radiator.

5. An electric vehicle for transporting individuals as in claim 1, wherein the electric vehicle includes an output port for the forced air.

6. An electric vehicle for transporting individuals as in claim 5, wherein the output port is positioned in front of the windshield.

7. An electric vehicle for transporting individuals as in claim 5, wherein the output port is positioned in the side of the electric vehicle.

8. An electric vehicle for transporting individuals as in claim 1, wherein the first battery and the second battery is positioned adjacent to the electric motor.

9. An electric vehicle for transporting individuals as in claim 1, wherein the first battery and the second battery is positioned adjacent to the trunk of the electric vehicle.
